(19) United States
(12) Patent Application Publication
(10) Pub. No.: US 2026/0095034 A1
(43) Pub. Date: Apr. 2, 2026

(54) DEVICE FOR AUTOMATICALLY MOUNTING PROTECTOR COVER

(71) Applicant: Yazaki Corporation, Tokyo (JP)

(72) Inventor: Takuya NAKADA, Makinohara-shi (JP)

(73) Assignee: Yazaki Corporation, Tokyo (JP)

(21) Appl. No.: 19/413,541

(22) Filed: Dec. 9, 2025

Related U.S. Application Data
(63) Continuation of application No. PCT/JP2024/021284, filed on Jun. 12, 2024.

(30) Foreign Application Priority Data
Jul. 13, 2023 (JP) 2023-115206

(51) Int. Cl. H02G 3/04

(52) U.S. Cl. CPC H02G 3/0418

(57) ABSTRACT

An automatic protector cover mounting device includes: a protector holding section for holding a protector main body; an operating section for attaching a protector cover to the protector main body; a movement means for moving the operating section. The operating section includes: a presser for pressing the protector cover toward the protector main body; a base with the presser mounted thereto, the presser being mounted to the base to be extendable out of the base and retractable into the base; and a sensor configured to detect a opposite amount of protrusion of the rod of the presser out of the base in a direction opposite to the protector holding section. Upon the opposite amount of protrusion of the rod being greater than or equal to a predetermined amount, the control section is configured to stop a pressing operation of the presser.

### CROSS REFERENCE TO RELATED APPLICATIONS

This application is a Bypass Continuation of International Application No. PCT/JP2024/021284, filed on June 12, 2024, which claims priority from Japanese Patent Application No. 2023-115206, filed on July 13, 2023, the contents of all of which are incorporated herein by reference in their entirety.

### BACKGROUND OF THE INVENTION

### Technical Field

The present invention relates to an automatic protector cover mounting device for attaching a protector cover to a protector main body.

### Background Art

For example, there is a wire harness to be arranged in a vehicle, wherein the wire harness includes an electric wire and a protector. The protector provides protection for the electric wire extending through the protector and is configured to be fixed in a vehicle body to limit a course along which the electric wire extends, wherein the protector includes a trough-shaped protector main body and a protector cover for closing an opening in the protector main body (see e.g. Patent Document 1).

The protector main body includes a locking portion and the protector cover includes a lock receiving portion. The protector cover is configured to be overlapped with and pressed against the protector main body to lock the lock receiving portion to the locking portion so that the protector cover is attached to the protector main body.

### Citation List

### Patent Literature

Patent Document 1: JP 2023-58059 A

### SUMMARY OF THE INVENTION

The protector is not automatically attached to the protector main body by machine, but manually. This is because it is difficult to adjust an amount of press for pressing the protector cover by machine automatic attachment. This means that a low amount of press results in failing to lock the lock receiving portion to the locking portion while a too high amount of press may result in a too high load applied to the protector, wherein adjustment of the amount of press is therefore difficult.

Therefore, an objective of the present invention is to enable a protector cover to be automatically mounted to the protector main body.

The present invention relates to an automatic protector cover mounting device including: a protector holding section configured to hold a protector main body while the protector main body is accommodating an electric wire of a wire harness; an operating section configured to attach a protector cover to the protector main body; and a movement means configured to move the protector holding section and the operating section relative to each other, wherein the operating section includes: a presser configured to press the protector cover toward the protector main body while the protector cover is overlapped with the protector main body; a base with the presser mounted thereto, the presser being mounted to the base to be extendable out of the base and retractable into the base; and a sensor configured to detect a opposite amount of protrusion of the presser out of the base in a direction opposite to the protector holding section, and wherein upon the opposite amount of protrusion of the presser being greater than or equal to a predetermined amount, the operating section is configured to provide a press stopping signal for stopping a pressing operation of the presser.

The present invention enables a protector cover to be automatically mounted to the protector main body.

### BRIEF DESCRIPTION OF THE DRAWINGS

FIG. 1 shows an automatic protector cover mounting device according to an embodiment of the present invention;

FIG. 2 shows an operating section in a view from another angle;

FIG. 3 shows a protector which may be attached by means of the automatic protector cover mounting device according to FIG. 1;

FIG. 4 shows an exploded view of the protector according to FIG. 3;

FIG. 5 shows how a protector main body is held by a protector holding section according to FIG. 1 and a protector cover is conveyed by the operating section;

FIG. 6 shows how the protector cover is placed over the protector main body by the operating section according to FIG. 5;

FIG. 7 shows how the protector cover is pressed toward the protector main body by the operating section according to FIG. 6; and

FIG. 8 shows an attached state of the protector cover according to FIG. 7 which is attached to the protector main body.

### DETAILED DESCRIPTION OF THE PREFERRED EMBODIMENTS

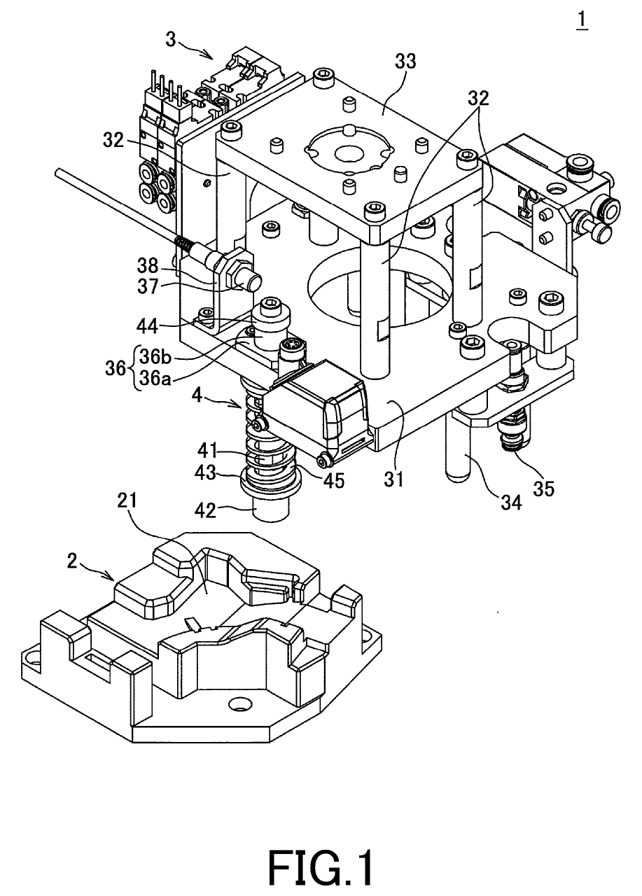

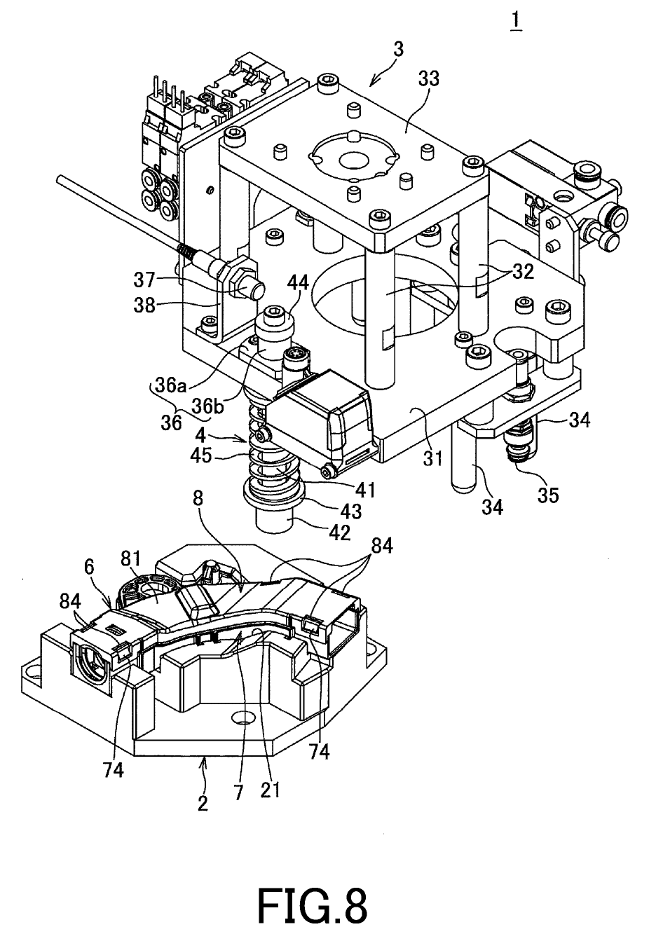

An “automatic protector cover mounting device” according to an embodiment of the present invention will be described with reference to FIGS. 1 to 8.

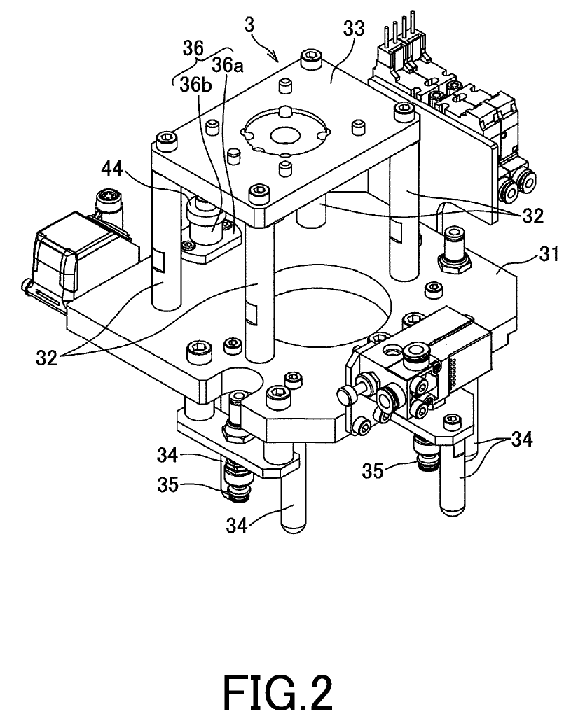

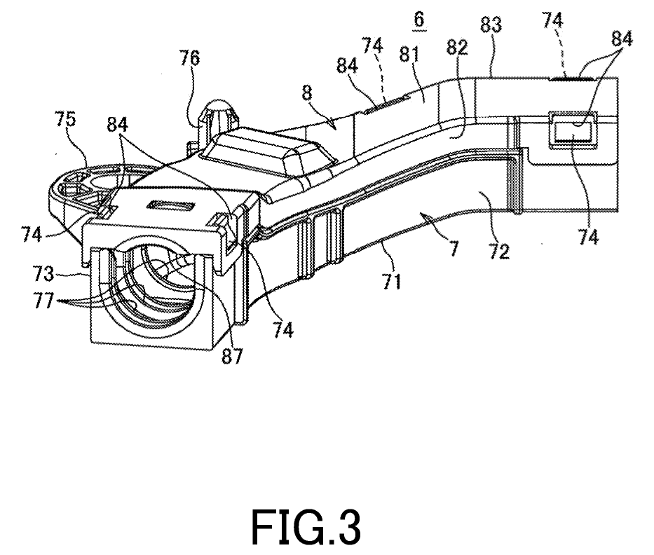

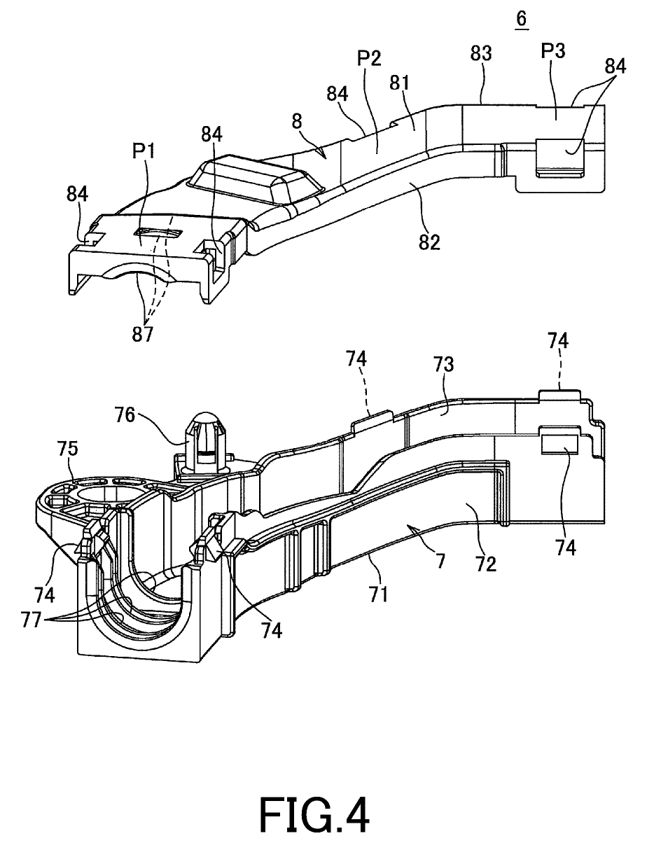

The automatic protector cover mounting device 1 as shown in FIGS. 1 and 2 is provided for attachment of a protector 6 as shown in FIGS. 3 and 4.

The protector 6 is provided for inserting a bundle of electric wires therethrough, with the bundle of electric wires having been covered with a corrugated tube, wherein the protector 6 provides protection for the bundle of electric wires and the corrugated tube and is configured to be fixed in a vehicle body to limit courses along which the bundle of electric wires and the corrugated tube extend. Furthermore, the protector 6 together with the bundle of electric wires and the corrugated tube form a wire harness for an automobile. The protector 6 includes a protector main body 7 and a protector cover 8, the protector main body 7 being formed with a resin and having a trough shape, wherein the protector cover 8 is formed with a resin and closes an opening in the protector main body 7.

The protector main body 7 includes a bottom wall 71, lateral walls 72 and 73, a bracket 75, and a vehicle body locking portion 76, the lateral walls 72 and 73 extending upward from opposite ends of the bottom wall 71 in its width direction, wherein the bracket 75 is configured to be fixed to the vehicle body and the vehicle body locking portion 76 is configured to be locked to the vehicle body. A plurality of ribs 77 is provided at one end portion of the protector main body 7 in its longitudinal direction, wherein the plurality of ribs 77 is configured to be received into grooves in the corrugated tube. A plurality of lock protrusions 74 is provided on outer faces of the lateral walls 72 and 73. More specifically, five lock protrusions 74 are provided, wherein a first lock protrusion 74 is provided at the one end portion of the lateral wall 72 in the longitudinal direction. A second lock protrusion 74 is provided at the other end portion of the lateral wall 72 in the longitudinal direction. A third lock protrusion 74 is provided at one end portion of the lateral wall 73 in the longitudinal direction. A fourth lock protrusion 74 is provided at the other end portion of the lateral wall 73 in the longitudinal direction. A fifth lock protrusion 74 is provided in a middle portion of the lateral wall 73 in the longitudinal direction. In addition, the lock protrusions 74 are provided at upper end portions of the lateral walls 72 and 73.

The protector cover 8 includes a ceiling wall 81 and lateral walls 82 and 83, wherein the lateral walls 82 and 83 are suspended downward from opposite ends of the ceiling wall 81 in its width direction. A plurality of ribs 87 is provided at one end portion of the protector cover 8 in its longitudinal direction, wherein the plurality of ribs 87 is configured to be received into grooves in the corrugated tube. A plurality of lock holes 84 is provided at the protector cover 8. More specifically, five lock holes 84 are provided, wherein a first lock hole 84 is formed to extend through the one end portion of the protector cover 8 in the longitudinal direction at a corner between the ceiling wall 81 and the lateral wall 82. A second lock hole 84 is formed to extend through the other end portion of the protector cover 8 in the longitudinal direction at a corner between the ceiling wall 81 and the lateral wall 82. A third lock hole 84 is formed to extend through the one end portion of the protector cover 8 in the longitudinal direction at a corner between the ceiling wall 81 and the lateral wall 83. A fourth lock hole 84 is formed to extend through the other end portion of the protector cover 8 in the longitudinal direction at a corner between the ceiling wall 81 and the lateral wall 83. A fifth lock hole 84 is formed to extend through a middle portion of the protector cover 8 in the longitudinal direction at a corner between the ceiling wall 81 and the lateral wall 83. The lock holes 84 are configured to be locked to the respective lock protrusions 74 provided on the protector main body 7.

The protector cover 8 is configured to be pressed toward the protector main body 7 by the pressor 4 of the automatic protector cover mounting device 1 while being placed over the protector main body 7 to lock the lock holes 84 to the respective lock protrusions 74 so that the protector cover 8 is attached to the protector main body 7. Although the bundle of electric wires and the corrugated tube are omitted in FIGS. 3 to 8, it is to be noted that practically, the protector cover 8 is attached to the protector main body 7 while the bundle of electric wires and the corrugated tube are accommodated in the protector main body 7. Furthermore, in a completely locked state of the lock holes 84 being completely locked to the respective lock protrusions 74, the lock protrusions 74 are visible from above (in a view toward the bottom wall 71 from the ceiling wall 81).

The automatic protector cover mounting device 1 includes a protector holding section 2 configured to hold the protector main body 7, an operating section 3 configured to attach the protector cover 8 to the protector main body 7, a movement means, such as a robot arm, configured to move the operating section 3, and a control section (not shown).

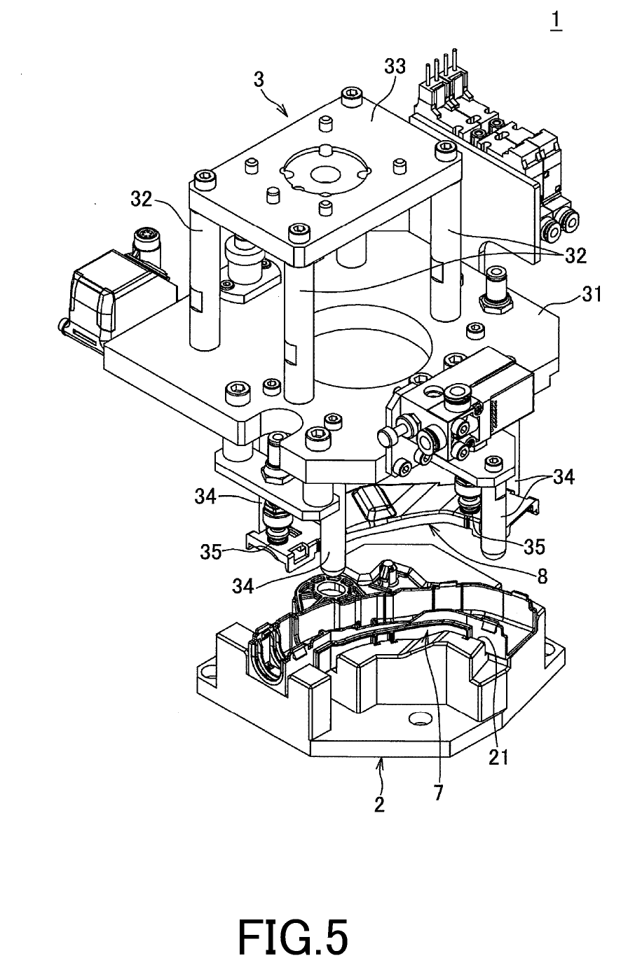

The protector holding section 2 includes a recess 21 and fixed to a frame, wherein the recess 21 has a shape corresponding to an outer face shape of the protector main body 7. The protector holding section 2 is configured to hold the protector main body 7 by fitting the protector main body 7 into the recess 21. Although the protector main body 7 is held by the protector holding section 2 with the bundle of electric wires and the corrugated tube being accommodated in the protector main body 7, the bundle of electric wires and corrugated tube are omitted in FIGS. 5 to 8.

The operating section 3 includes a plate-shaped base 31, a coupling plate 33 coupled to the movement means, coupling rods 32 connecting the base 31 to the coupling plate 33, a pair of sucker sections 35 and one or more suction means, a plurality of guide rods 34, the presser 4, a sensor 37, and a camera.

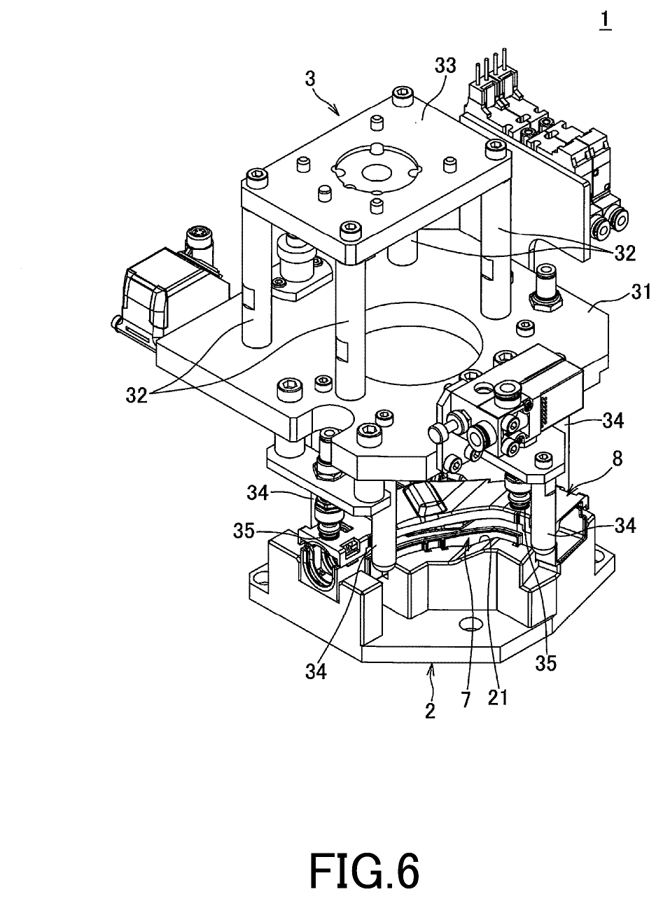

As shown in FIGS. 5 and 6, the pair of sucker sections 35 is provided for picking up the protector cover 8 and then conveying it to the protector holding section 2, with the protector main body 7 being held by the protector holding section 2. The pair of sucker sections 35 is positioned on a lower side of the base 31. The pair of sucker sections 35 is connected to the one or more suction means, wherein the suction means is/are configured to suction air while the pair of sucker sections 35 is in contact with the ceiling wall 81 of the protector cover 8, whereby the sucker sections 35 are attached to the ceiling wall 81. The movement means is configured to move the operating section 3 in this state in order to convey the protector cover 8. After the protector cover 8 has been conveyed to the protector holding section 2, air is transported to the pair of sucker sections 35 from the suction means so that the protector cover 8 is released from the pair of sucker sections 35. The protector cover 8 is thus placed over the protector main body 7.

The plurality of guide rods 34 is suspended from the lower side of the base 31. When the protector cover 8 is picked up and conveyed by the pair of sucker sections 35, the plurality of guide rods 34 is moved along the lateral walls 82 and 83 so that the protector cover 8 is positioned.

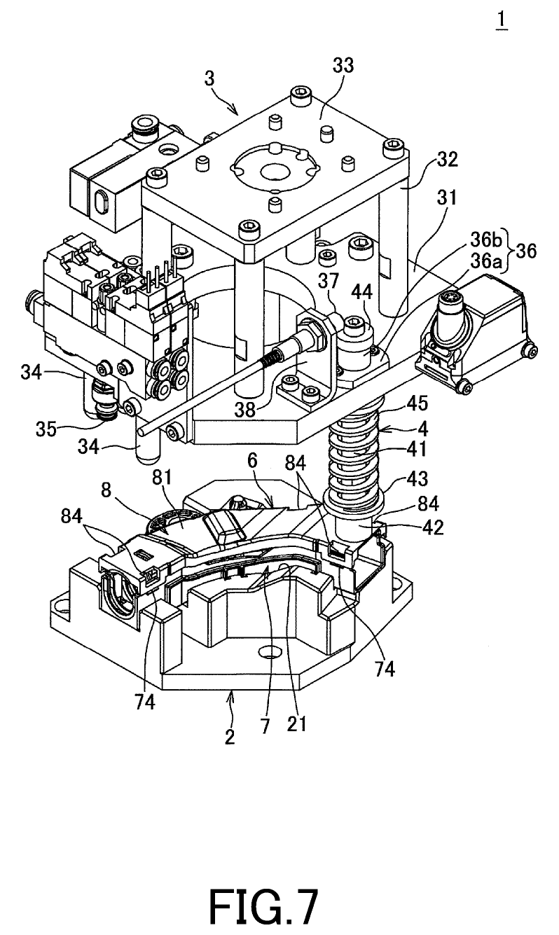

As shown in FIG. 7, the presser 4 is configured to press the protector cover 8 against the protector main body 7 while the protector cover 8 is placed over the protector main body 7. In the present example, the presser 4 is further configured to press the ceiling wall 81 of the protector cover 8 at three points P1, P2 and P3 of the ceiling wall 81 (see FIG. 4). The three points of the ceiling wall 81 are pressed in the following sequence: first, the first point P1 is pressed, then the second point P2, and the third point P3 is pressed finally, wherein the ribs 87 which are received into the grooves in the corrugated tube are provided at the first point P1. The presser 4 includes a cylindrical rod 41, a presser head 42, a metallic portion 44, a collar 43, and a coil spring 45, wherein the presser head 42 and the metallic portion 44 are provided at a lower end portion and at an upper portion of the rod 41. The collar 43 is connected to an upper end of the presser head 42.

The rod 41 is held by the base 31 via a mounting component 36, wherein the mounting component 36 is attached onto an upper side of the base 31. The mounting component 36 includes a hollow cylindrical portion 36b and a flange portion 36a, wherein the flange portion 36a is connected to the hollow cylindrical portion 36b and fixed to the base 31. The base 31 includes a through hole which is connected to the hollow cylindrical portion 36b. The rod 41 is inserted into the inside of the hollow cylindrical portion 36b and the through hole in the base 31 so that the rod 41 is extendable out of the hollow cylindrical portion 36b and the base 31 as well as retractable into the hollow cylindrical portion 36b and the base 31 (movable upward and downward). The metallic portion 44 has a size which does not allow the metallic portion 44 to be inserted through the hollow cylindrical portion 36b, wherein the metallic portion 44 is placed above the hollow cylindrical portion 36b. The coil spring 45 is positioned at an outer periphery of the rod 41 and between the base 31 and the collar 43 so that the collar 43 and the presser head 42 are biased downward, i.e., toward the protector holding section 2, by the coil spring 45.

The presser head 42 presses the ceiling wall 81 of the protector cover 8 toward the protector main body 7 by the movement means moving the operating section 3 downward, i.e., toward the protector holding section 2, by a predetermined distance. When the presser head 42 presses the protector cover 8, the coil spring 45 is compressed so that an amount of protrusion of the rod 41 is increased which protrudes upward (in a direction opposite to the protector holding section 2) out of the base 31. In this manner, an amount of press for pressing the protector cover 8 by the presser head 42 according to the present example is adjusted to a proper amount via an amount of upward/downward movement of the operating section 3 by the movement means and via an elastic force of the coil spring 45. The amount of press can be varied as appropriate via change in the amount of movement of the operating section 3 or via change of the coil spring 45.

The sensor 37 is configured as a proximity sensor which detects in a non-contact manner that a detected object has approached. The sensor 37 is fixed on an upper side of the base 31 via a fixing component 38. In a state of the presser head 42 which is not pressing the protector cover 8, the sensor 37 is positioned above the metallic portion 44 as the detected object. The metallic portion 44 is moved toward the sensor 37 by the presser head 42 pressing the protector cover 8. When the amount of press of the presser head 42 is greater than or equal to a predetermined amount, the amount of upward protrusion of the rod 41 out of the base 31 is greater than or equal to a predetermined amount, wherein the sensor 37 then detects it and sends a press stopping signal to the control section, wherein the press stopping signal is provided for stopping the pressing operation.

When the press stopping signal (indicative of that the amount of press of the presser head 42 is greater than or equal to the predetermined amount) is sent by the sensor 37, the control section issues an alert and controls a driving operation of the movement means to stop the pressing operation by the presser 4. This may prevent that an overload is applied to the protector cover 8 by the presser 4. In a normal state, the amount of press of the presser head 42 may not be greater than or equal to the predetermined amount. However, the amount of press may be greater than or equal to the predetermined amount, for example in case of misalignment of the protector main body 7 with the protector cover 8.

After the protector cover 8 is pressed and attached to the protector main body 7 as described above, the camera included in the operating section 3 images the protector 6 from above. The image data is processed in the control section to automatically determine whether each of the lock holes 84 is completely locked to a corresponding one of the lock protrusions 74. If it is determined that the lock holes 84 are completely locked to the respective lock protrusions 74, a corresponding completed product is delivered to the outside. If it is determined that the lock holes 84 are incompletely locked to the respective lock protrusions 74, the control section issues the alert.

As described above, the automatic protector cover mounting device 1 has a simplified structure while enabling the protector cover 8 to be pressed with a proper pressing force and to be thus attached to the protector main body 7 automatically. Moreover, it is possible to prevent that an overload is applied to the protector cover 8 by the presser 4.

According to the above-mentioned embodiment, the opposite amount of protrusion of the presser 4 in the direction opposite to the protector holding section 2 is detected by the proximity sensor 37. However, according to the present invention, an optical sensor and/or a microswitch may be used instead of the proximity sensor, for example.

According to the above-mentioned embodiment, the protector holding section 2 is fixed to the frame, wherein the operating section 3 is moved relative to the protector holding section 2 by means of the movement means. However, according to the present invention, the protector holding section 2 may be configured to be moved relative to the operating section 3 by means of the movement means.

It is to be noted that the embodiments as described above merely illustrate representative examples for the present invention, and the present invention is not limited to these embodiments. I.e., various modifications may be performed without departing from the core of the present invention. It is obvious that such modifications are included in the scope of the present invention as far as the modifications comprise the features of the present invention.

### Reference Signs List

1 Automatic protector cover mounting device

2 Protector holding section

3 Operating section

4 Presser

6 Protector

7 Protector main body

8 Protector cover

31 Base

37 Sensor

41 Rod

42 Presser head

45 Coil spring

1. An automatic protector cover mounting device comprising:
a protector holding section configured to hold a protector main body while the protector main body is accommodating an electric wire of a wire harness;
an operating section configured to attach a protector cover to the protector main body; and
a movement means configured to move the protector holding section and the operating section relative to each other,
wherein the operating section includes:
a presser configured to press the protector cover toward the protector main body while the protector cover is overlapped with the protector main body;
a base with the presser mounted thereto, the presser being mounted to the base to be extendable out of the base and retractable into the base; and
a sensor configured to detect a opposite amount of protrusion of the presser out of the base in a direction opposite to the protector holding section, and
wherein upon the opposite amount of protrusion of the presser being greater than or equal to a predetermined amount, the operating section is configured to provide a press stopping signal for stopping a pressing operation of the presser.

2. The automatic protector cover mounting device according to claim 1,
wherein the presser includes:
a rod inserted into the base to be extendable out of the base and retractable into the base;
a presser head provided at an end portion of the rod; and
a coil spring disposed at an outer periphery of the rod and between the base and the presser head, and
wherein upon pressing the protector cover by the presser head, the coil spring is configured to be compressed so that an opposite amount of protrusion of the rod out of the base in a direction opposite to the protector holding section is increased.
